(19) United States
(12) Patent Application Publication
(10) Pub. No.: US 2014/0218274 A1
(43) Pub. Date: Aug. 7, 2014

(54) DISPLAY PANEL

(71) Applicants: INNOCOM TECHNOLOGY (SHENZHEN) CO., LTD, (US); INNOLUX CORPORATION, Chu-Nan (TW)

(72) Inventor: Keitaro YAMASHITA, Chu-Nan (TW)

(73) Assignees: InnoLux Corporation, Chu-Nan (TW); INNOCOM TECHNOLOGY (SHENZHEN) CO., LTD, Shenzhen City (CN)

(21) Appl. No.: 13/761,913

(22) Filed: Feb. 7, 2013

(51) Int. Cl. G09G 3/34

(52) U.S. Cl. CPC G09G 3/3406
USPC 345/84

(57) ABSTRACT

A display panel comprises a plurality of scan lines and a scan driving circuit having a plurality of stages in series, each of stages comprising a shift register unit and a compensation unit. The shift register unit and the compensation unit in the same stage are at the opposite sides of the display panel. Each of the scan lines is electrically connected with the shift register unit and the compensation unit in the same stage. When a first shift register unit of a first stage located on a side of the display panel outputs a scan signal to a terminal of the scan line, one of a second shift register unit of a previous stage and a third shift register unit of a next stage both located on the other side controls the compensation unit outputting a control signal to the other terminal of the scan line synchronously.

### BACKGROUND OF THE INVENTION

1. Field of Invention

The invention relates to a display panel.

2. Related Art

In general, a display panel mainly includes a panel body, a scan driving circuit and a data driving circuit. The data driving circuit is disposed on the panel body for driving a plurality of pixels of the display panel through a plurality of data lines. The scan driving circuit is disposed on the panel body for driving the pixels through a plurality of scan lines. Moreover, the scan driving circuit includes a shift register for transmitting scan signals to sequentially enable the scan lines, which are connected to the shift register, thereby driving the pixels.

Recently, large-size panels have been widely produced, and for solving the signal decay problem caused by the overlong transmission distance for the large-size panels, dual-side scan driving method has been proposed, distributing the shift register over the opposite sides of the display panel to mitigate the signal decay problem. However, it's always a topic to find a circuit design that can more effectively compensate the scan signals. Disposing identical gate drivers on left and right borders of the panel may diminish the signal decaying problem, but however this approach makes the panel's border width wider.

Therefore, it is an important subject to provide a display panel that can effectively compensate the scan signals outputted by the shift register so as to enhance display efficiency with narrow panel border.

### SUMMARY OF THE INVENTION

In view of the foregoing subject, an objective of the invention is to provide a display panel that can effectively compensate the scan signals outputted by the shift register circuit so as to enhance display efficiency with narrow panel border.

To achieve the above objective, a display panel according to the embodiments of the invention comprises a plurality of scan lines and a scan driving circuit. The scan driving circuit has a plurality of stages in series, each of stages comprising a shift register unit and a compensation unit. The shift register unit and the compensation unit in the same stage are at the opposite sides of the display panel. Two terminals of each of the scan lines are respectively electrically connected with the shift register unit and the compensation unit in the same stage. When a first shift register unit of a first stage located on a side of the display panel outputs a scan signal to a terminal of the scan line, one of a second shift register unit of a previous stage and a third shift register unit of a next stage both located on the other side controls the compensation unit outputting a control signal to the other terminal of the scan line synchronously.

In one embodiment, the control signal is generated according to a first clock signal. The control signal is a pulse signal for example.

In one embodiment, the compensation unit is controlled by the signal of a second main node of the second shift register unit and the signal of a third main node of the third shift register unit of the next stage, and at least one of the signals of the second and third main nodes has a high level voltage higher than the high level voltage of the scan signal.

In one embodiment, the third shift register unit is the next stage of the first shift register unit.

In one embodiment, the compensation unit includes two transistors, and the signals of the main nodes control the gate terminals of the transistors, respectively.

In one embodiment, a first terminal of each of the transistors is coupled to the scan line while a second terminal of each of the transistors is controlled by the first clock signal.

In one embodiment, the first shift register unit includes a first transistor, a capacitor, and a first main node, one terminal of the capacitor is coupled to the first main node and the gate terminal of the first transistor, and the other terminal of the capacitor is coupled to a first terminal of the first transistor and the scan line.

In one embodiment, a second terminal of the first transistor is controlled by the first clock signal.

In one embodiment, the first shift register unit further includes a second transistor and a third transistor, a first terminal of the second transistor and a second terminal of the third transistor are both coupled to the first main node, a second terminal and gate terminal of the second transistor are coupled to each other, a first terminal of the third transistor is directly coupled to a low level voltage.

In one embodiment, the gate terminal of the third transistor is controlled by a scan signal outputted by a fourth shift register unit.

In one embodiment, the fourth shift register unit is the next second stage of the first shift register unit.

In one embodiment, the gate terminal of the third transistor is controlled by a second clock signal, and the pulse of the second clock signal is not overlapped with that of the first clock signal.

In one embodiment, the gate terminal and second terminal of the second transistor are controlled by a scan signal outputted by the second shift register unit.

In one embodiment, the second shift register unit is controlled by a third clock signal, and the pulse of the third clock signal is overlapped with that of the first clock signal.

In one embodiment, the third shift register unit is controlled by a fourth clock signal, and the pulse of the fourth clock signal is overlapped with that of the first clock signal but not overlapped with that of the third clock signal.

In one embodiment, the second shift register unit is controlled by a third clock signal, and the pulse of the third clock signal is not overlapped with that of the first clock signal.

In one embodiment, the third shift register unit is controlled by a fourth clock signal, and the pulse of the fourth clock signal is not overlapped with that of the first clock signal and that of the third clock signal.

In one embodiment, the first shift register unit further includes a fourth transistor, a fifth transistor, and a sixth transistor, the gate terminal of the fourth transistor, a first terminal of the fifth transistor, and a second terminal of the sixth transistor are all coupled to the first main node, a first terminal of the fourth transistor and a first terminal of the sixth transistor are both directly coupled to a low level voltage, a second terminal of the fourth transistor is coupled to the scan line, and a second terminal and the gate terminal of the fifth transistor are coupled to each other.

In one embodiment, the first shift register unit further includes a seventh transistor, a first terminal of the seventh transistor is coupled to the first main node, and a second terminal and gate terminal of the seventh transistor are coupled to each other.

In one embodiment, the signal of the first main node has a high level higher than the high level of the scan signal outputted by the first shift register unit.

As mentioned above, in the display panel of the invention, a stage of the shift register unit is corresponding to a compensation unit, and the shift register unit and the compensation unit are located on the opposite sides of the display panel, respectively connecting to two terminals of the scan line for charging and discharging the scan line through the two terminals. Thereby, the scan signal is compensated to maintain the waveform after the signal transmission, and the time required for the rising of the rising edge and the falling of the falling edge of the scan signal can be reduced so as to enhance display efficiency, such as decreasing flicker. Besides, the compensation unit is controlled by the main node signal of at least a shift register unit located on the same side as the compensation unit, and the main node signal has a high level higher than the level of the scan signal, so the compensation unit can be driven to highly effectively compensate the corresponding shift register unit.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a block diagram of a display panel according to a preferred embodiment of the invention;

FIG. 2 is a schematic diagram of a plurality of stages of the shift register units and a plurality of compensation units according to a preferred embodiment of the invention;

FIG. 3 is a timing chart of the control signals of the shift register modules and the compensation units in FIG. 2;

FIGS. 4A and 4B are waveform diagrams of the scan signal located on the first side and second side of the display panel, respectively, according to a preferred embodiment of the invention;

FIG. 5 is a schematic diagram of a plurality of stages of the shift register units and a plurality of compensation units according to another preferred embodiment of the invention;

FIG. 6 is a timing chart of the control signals of the shift register modules and the compensation units in FIG. 5; and

FIGS. 7 and 8 are schematic diagrams of the shift register units of other embodiments of the invention.

### DETAILED DESCRIPTION OF THE INVENTION

The present invention will be apparent from the following detailed description, which proceeds with reference to the accompanying drawings, wherein the same references relate to the same elements.

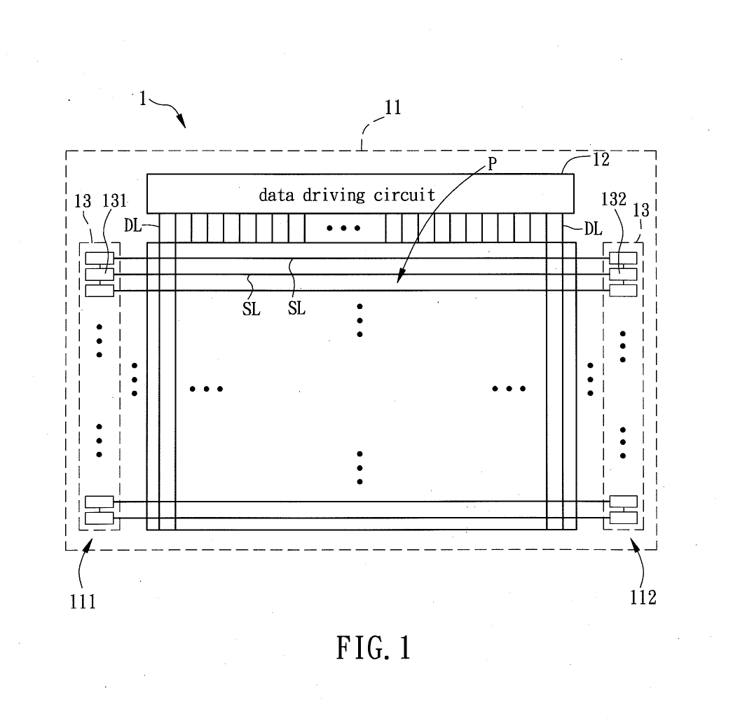

FIG. 1 is a block diagram of a display panel 1 according to a preferred embodiment of the invention. The display panel 1 is not limited in type, which can be, for example, a liquid crystal display (LCD) panel or other flat display panels. The display panel 1 includes a panel body 11, a data driving circuit 12, and a scan driving circuit 13. The panel body 11 includes a plurality of pixels disposed in an array. As an embodiment for example, the panel body 11 can be an LCD panel body including two opposite substrates and an LC layer disposed between the substrates. The two substrates can be, for example, a thin film transistor (TFT) substrate and a color filter (CF) substrate, respectively. The two substrates and the LC layer constitute the pixels. However, the invention is not limited thereto. The substrates can be varied otherwise. For example, the color filter layer can be disposed on the TFT substrate (i.e. color filter on array, COA), or the color filter layer and black matrix can be disposed on the TFT substrate (i.e. black matrix on array, BOA), or the TFT array can be disposed on the CF substrate (i.e. TOC, array on CF).

The data driving circuit 12 is disposed on the panel body 11 and drives the pixels P through a plurality of data lines DL. The scan driving circuit 13 is disposed on the panel body 11 and drives the pixels through a plurality of scan lines SL. Of course, the display panel 1 can further include, for example, a timing controller (not shown) which can output horizontal and vertical synchronous signals to control the timings of the data driving circuit and scan driving circuit.

The scan driving circuit 13 includes a plurality of stages in series, each of the stages including a shift register units 131 and a compensation units 132. The shift register unit and the compensation unit in the same stage are at the opposite sides of the display panel, i.e. a first side 111 and a second side 112. The invention doesn't limit the relative positions of the first side 111 and second side 112, and herein as an example, the first side is the left side of the display panel 11 while the second side 112 is the right side of the display panel 11. Two terminals of each of the scan lines SL are respectively connected to the shift register unit and the compensation unit in the same stage, and that is, each of the scan lines SL is corresponding to a shift register unit 131 and a compensation unit 132.

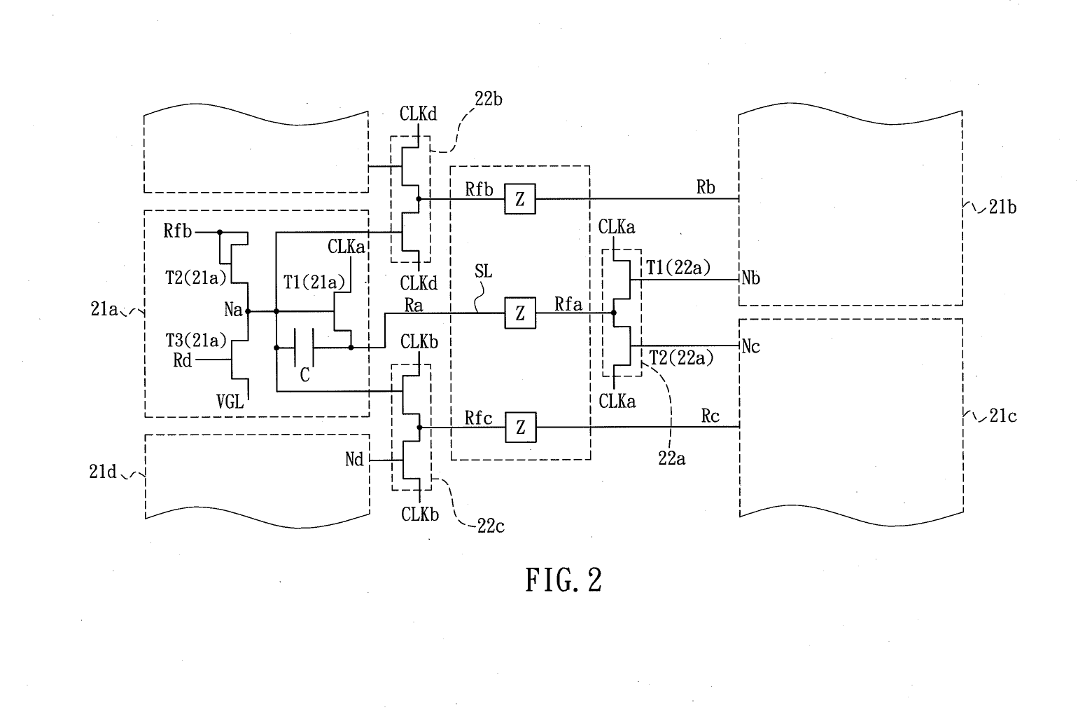

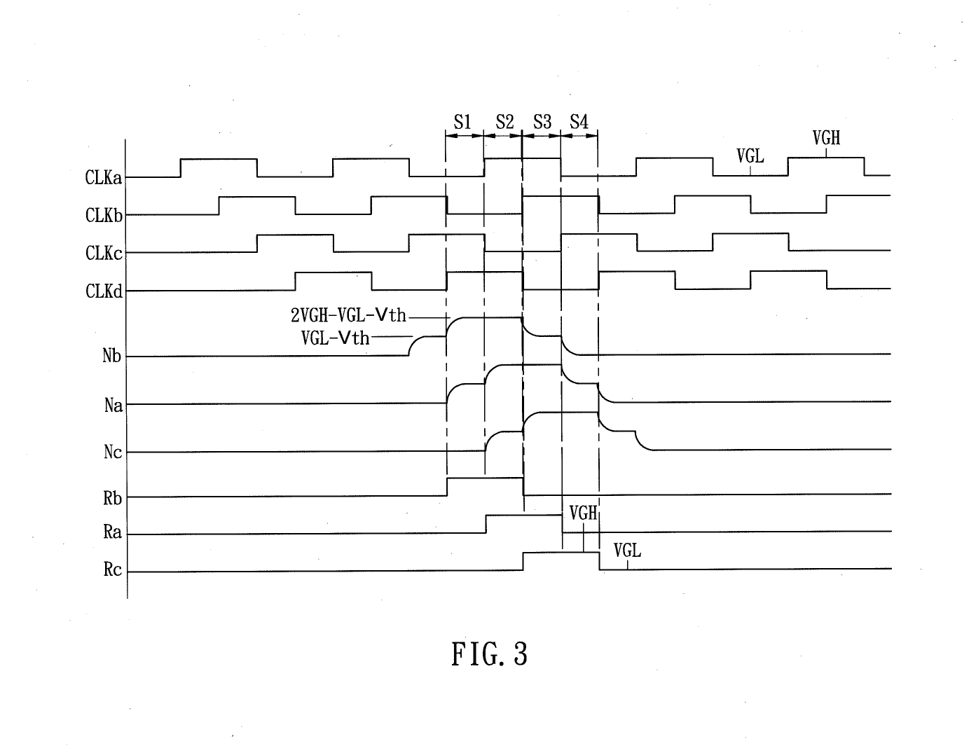

The following is related to the operation of the shift register module 131 and compensation unit 132, illustrated by referring to FIGS. 2 and 3. FIG. 2 is a schematic diagram of the shift register units and compensation units of some stages according to a preferred embodiment of the invention, and FIG. 3 is a timing chart of the control signals of the shift register modules and the compensation units in FIG. 2.

FIG. 2 shows a first shift register unit 21a, a second shift register unit 21b, a third shift register unit 21c, and a fourth shift register unit 21d, and this embodiment is illustrated by these shift register units 21a˜21d. Besides, the second shift register unit 21b is the previous stage of the first shift register unit 21a, the third shift register unit 21c is the next stage of the first shift register unit 21a, and the fourth shift register unit 21d is the next second stage of the first shift register unit 21a, i.e. the next stage of the third shift register unit 21c. However, the invention is not limited thereto. To be noted, the first shift register unit 21a can be substantially any stage of the shift register units by analogy, and then the corresponding second, third and fourth shift register units can be ascertained by analogy.

Herein, the first shift register unit 21a is corresponding to a compensation unit 22a. The first shift register unit 21a is located on the first side (as shown in FIG. 1) while the compensation unit 22a is located on the second side 112 (as shown in FIG. 1). Two terminals of the scan line SL are respectively connected to the first shift register unit 21a and the compensation unit 22a. The compensation unit 22a is controlled by at least a shift register unit located on the second side (i.e. the opposite side of the first side). In this embodiment, the compensation unit 22a is controlled by, for example, a second shift register unit 21b and a third shift register unit 21c both located on the second side. Besides, herein, the compensation unit 22a is controlled by the signal of a second main node Nb of the second shift register unit 21b and the signal of a third main node Nc of the third shift register unit 21c, and also by a first clock signal CLKa which also synchronously controls the first shift register unit 21a. When the first shift register unit 21a outputs a scan signal to a terminal (on the first side) of the corresponding scan line SL, the second shift register unit 21b and the third shift register unit 21c control the compensation unit 22a outputting a control signal to the other terminal (on the second side) of the scan line SL synchronously, thus charging the scan line for compensating and enhancing the scan signal. Herein, the control signal is generated according to the first clock signal CLKa, and can be a pulse signal for example.

Specifically, the compensation unit 22a includes two transistors T1(22a), T2(22a), and the signals of the second and third main nodes Nb, Nc control the gate terminals of the transistors T1(22a), T2(22a), respectively. Besides, the first terminals of the transistors T1(22a), T2(22a) are coupled to each other and the scan line SL. The second terminals of the transistors T1(22a), T2(22a) are controlled by the first clock signal CLKa. To be noted first, in the descriptions of the all embodiments of the invention, the first terminal of the transistor means the source terminal while the second terminal means the drain terminal, for example, based on the N-type transistor. However, as long as the voltage level is properly adjusted, P-type transistors also can be applied to these embodiments. What is herein notable is that the T1(22a) and T2(22a) of the compensation unit 22a are fully turned on by applying the gate voltage much higher than a high level voltage VGH which is commonly used conventionally, and the gate voltage is provided by the main nodes Nb and Nc instead of other elements. Generally, the conductance of N-type transistor becomes higher with the gate voltage higher than VGH. Thus, the use of much higher voltage than VGH to the transistors T1(22a) and T2(22a) of compensation unit 22a allows smaller size of transistors, thereby causing the required circuit area to be reduced. This is the significant feature to keep the display border narrower whilst the compensation unit surely compensates the signal decay.

The first shift register unit 21a includes a first transistor T1(21a), a capacitor C, and a first main node Na. One terminal of the capacitor C is coupled to the first main node Na and the gate terminal of the first transistor T1(21a), and the other terminal of the capacitor C is coupled to the first terminal of the first transistor T1(21a) and the scan line SL. The second terminal of the first transistor T1 (21a) is controlled by the first clock signal CLKa. The first shift register unit 21a further includes a second transistor T2(21a) and a third transistor T3(21a). The first terminal of the second transistor T2(21a) and the second terminal of the third transistor T3(21a) are both coupled to the first main node Na. The second terminal and gate terminal of the second transistor T2(21a) are coupled to each other, formed into a so-called diode connection. The first terminal of the third transistor T3(21a) is directly coupled to a low level voltage VGL. The gate terminal of the third transistor T3(21a) is controlled by a scan signal Rd outputted by the fourth shift register unit 21d, and the scan signal Rd comes from the first side 111. The gate terminal and second terminal of the second transistor T2(21a) are controlled by a scan signal Rfb outputted by the second shift register unit 21b, and the scan signal Rfb comes from the first side 111. The second shift register unit 21b is controlled by a third clock signal CLKd, the pulse of which is overlapped with that of the first clock signal CLKa. The third shift register unit 21c is controlled by a fourth clock signal CLKb, the pulse of which is overlapped with that of the first clock signal CLKa but not overlapped with that of the third clock signal CLKd. Besides, in this embodiment, the fourth, second and third clock signals CLKb, CLKc and CLKd differ from the first clock CLKa by ¼, ½ and ¾ phases, respectively. However, the invention is not limited thereto.

Regarding the operation during the section S1, the scan signal Rfb (almost equal to the scan signal Rb in FIG. 3) goes to a high level voltage VGH so that the capacitor C is charged through the second transistor T2(21a ) having a diode connection. Meanwhile, the signal level of the first main node Na goes to VGH-Vth to allow the first transistor T1(21a ) to be turned on. Then during the section S2, the first clock signal CLKa goes to the high level voltage VGH, and the pulse of the first clock signal CLKa is outputted to the scan line SL through the first transistor T1(21a ) and flows to the scan signal Ra. Because the capacitor C with one terminal coupled to the scan line SL can provide a bootstrapping effect, the level (voltage) of the other terminal of the capacitor C and first main node is pushed up to 2VGH-VGL-Vth, which is much higher than the high level voltage VGH, according to the boosting of the first clock signal CLKa. Thereby, the first transistor T1(21a ) is fully turned on, so the scan signal Ra can be rapidly charged to go to the high level voltage VGH. The aforementioned description is related to the charging of the scan line.

Besides, during the section S2, the signal of the second main node Nb also goes to 2VGH-VGL-Vth first and then remains at 2VGH-VGL-Vth, which is much higher than the high level voltage VGH to allow the transistor T1(22a) of the compensation unit 22a to be fully turned on. Meanwhile, the first clock signal CLKa coupled to the second terminal of the transistor T1(22a) also goes to the high level voltage VGH. Thereby, the charging to the scan line is also provided through the transistor T1(22a) of the compensation unit 22a. Accordingly, in this embodiment, the charging to the scan line is provided through both of the shift register unit on the first side and the compensation unit on the second side synchronously so as to minimize the scan signal's decay.

The following description is related to the discharging to the scan line. During the section 54, the first clock signal CLKa goes to the low level VGL for performing the discharging to the scan line. Meanwhile, the signal of the third main node Nc also goes to 2VGH-VGL-Vth first and then remains at 2VGH-VGL-Vth, which is much higher than the high level voltage VGH to allow the transistor T2(22a) of the compensation unit 22a to be fully turned on. Moreover, the second terminal of the transistor T2(22a) is coupled to the first clock signal CLKa going to the low level voltage VGL. As a result, the scan line SL is discharged not only through the third transistor T3(21a ) but also through the transistor T2(22a). Thereby, the discharging to the scan line SL can be rapidly completed.

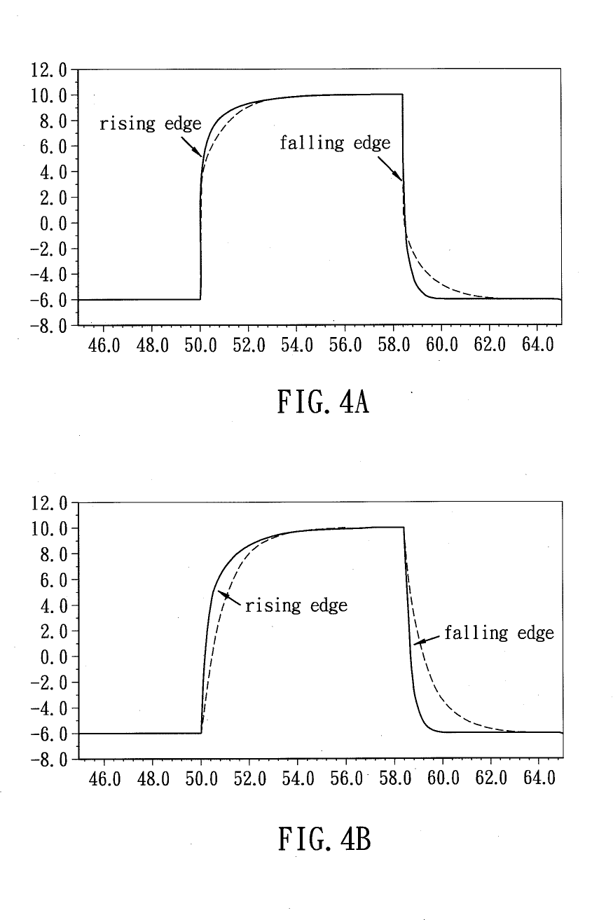

Therefore, by referring to FIG. 4A showing the waveform of the scan signal Ra wherein the solid line represents the case with the compensation unit and the dashed line represents the case without the compensation unit, the rising edge and falling edge of the scan signal Ra compensated by the compensation unit just require less time for rising and falling, respectively. Similarly, in FIG. 4B showing the scan signal Rfa wherein the solid line represents the case with the compensation unit and the dashed line represents the case without the compensation unit, the rising edge and falling edge of the scan signal Rfa outputted by the compensation unit also require less time for rising and falling, respectively. That is, the scan signal of the embodiment can overcome the decay and deformation in waveform caused by the impedance Z associated with a distribution time constant (as shown in FIG. 2) generated by the transmission route of the scan signal.

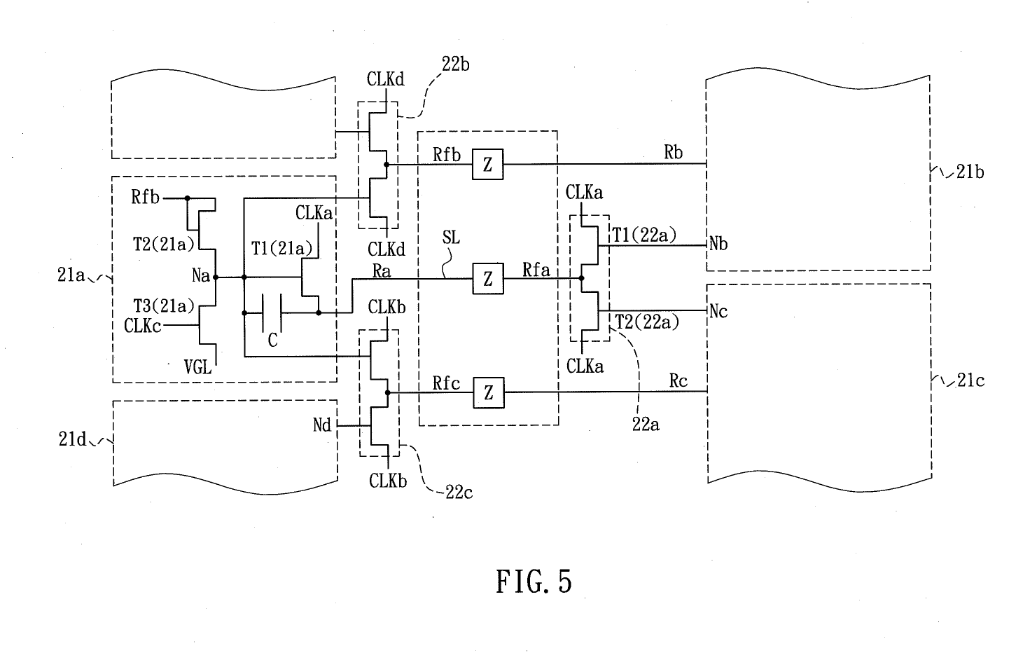

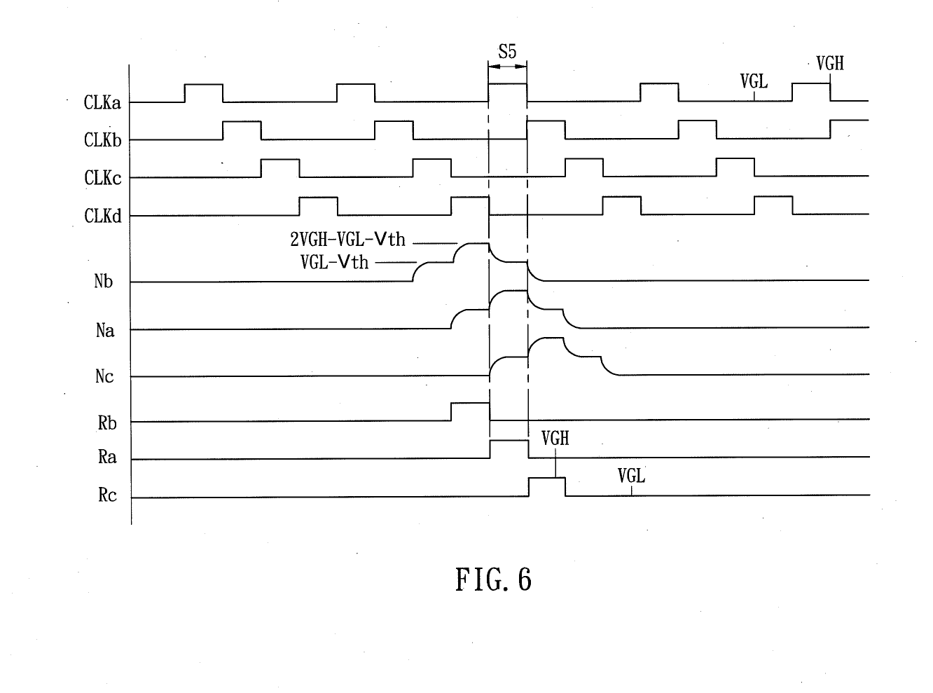

FIG. 5 is a schematic diagram of a plurality of stages of shift register units and a plurality of compensation units according to another preferred embodiment of the invention, and FIG. 6 is a timing chart of the control signals of the shift register modules and the compensation units in FIG. 5.

Different from the above embodiment, the gate terminal of the third transistor T3(21a ) of this embodiment is controlled by a second clock signal CLKc. The pulse of the second clock signal CLKc is not overlapped with that of the first clock signal CLKa. Besides, the pulse of a third clock signal CLKd controlling the second shift register unit 21b is also not overlapped with that of the first clock signal CLKa. In addition, the pulse of a fourth clock signal CLKb controlling the third shift register unit 21c is also not overlapped with that of the first clock signal CLKa and that of the third clock signal CLKd. Specifically, the first to fourth clock signals CLKa to CLKb of this embodiment are not overlapped with one another.

Similar to the embodiment as shown in FIGS. 2 and 3, the charging to the scan line SL of this embodiment also can be provided through the transistor T1(22a). During the section S5, the signal pulse of the second main node Nb just falls down along a slope determined by the time constant of the resistance-capacitance effect. Although the level of the second main node Nb exceeds the level VGH for a short time, the scan signal Rfa still can be charged through the transistor T1(22a) before the level of the first main node Na falls down to VGH-Vth.

Moreover, some elements can be added to the shift register unit of the invention for achieving higher or particular efficiency. There are some examples as below.

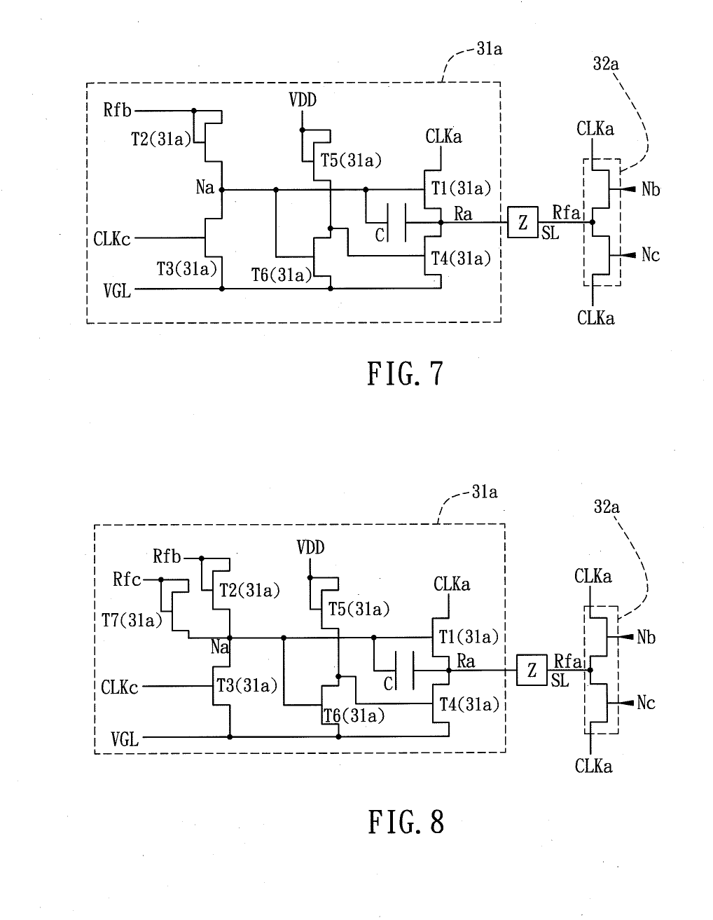

FIG. 7 shows a shift register unit 31a and a compensation unit 32a. Different from the above embodiments, the shift register unit 31a of this embodiment further includes a fourth transistor T4(31a ), a fifth transistor T5(31a ), and a sixth transistor T6(31a). The gate terminal of the fourth transistor T4(31a), the first terminal of the fifth transistor T5(31a), and the second terminal of the sixth transistor T6(31a) are all coupled to the first main node Na. The first terminal of the fourth transistor T4(31a) and the first terminal of the sixth transistor T6(31a) are both directly coupled to a low level voltage VGL. The second terminal of the fourth transistor T4(31a) is coupled to all of the scan line SL, the first terminal of the first transistor T1(31a ), and the capacitor C. The second terminal and gate terminal of the fifth transistor T5(31a) are coupled to each other.

In this embodiment, the fourth, fifth and sixth transistors are used for discharging the scan line SL. Thereby, the shift register unit 31a can be more robust against noise. Because other technical features of this embodiment have been illustrated clearly in the above embodiments, they are not described here for concise purpose.

Referring to FIG. 8, different from the above embodiments, the shift register unit 31a of this embodiment further includes a seventh transistor T7(31a). The first terminal of the seventh transistor T7(31a) is coupled to the first main node Na, and the second terminal and gate terminal of the seventh transistor T7(31a) are coupled to each other. By the disposition of the seventh transistor, the shift register units of this embodiment and the shift register including the stages of the shift register units can be applied to the reverse scan technology. Because other technical features of this embodiment have been illustrated clearly in the previous embodiments, they are not described here for concise purpose.

In summary, in the display panel of the invention, a stage of the shift register unit is corresponding to a compensation unit, and the shift register unit and the compensation unit are located on the opposite sides of the display panel, respectively connecting to two terminals of the scan line for charging and discharging the scan line through the two terminals. Thereby, the scan signal is compensated to maintain the waveform after the signal transmission, and the time required for the rising of the rising edge and the falling of the falling edge of the scan signal can be reduced so as to enhance display efficiency, such as decreasing flicker. Besides, the compensation unit is controlled by the main node signal of at least a shift register unit located on the same side as the compensation unit and the main node signal has a high level higher than the level of the scan signal, so the compensation unit can be driven to highly effectively compensate the corresponding shift register unit. By such shift register unit with the compensation unit, the signal decay problem is diminished with maintaining the narrow panel border which is indispensable in high resolution display.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display panel, comprising:
a plurality of scan lines; and
a scan driving circuit having a plurality of stages in series, each of stages comprising a shift register unit and a compensation unit, wherein the shift register unit and the compensation unit in the same stage are at the opposite sides of the display panel:
wherein two terminals of each of the scan lines are respectively electrically connected with the shift register unit and the compensation unit in the same stage, when a first shift register unit of a first stage located on a side of the display panel outputs a scan signal to a terminal of the scan line, one of a second shift register unit of a previous stage and a third shift register unit of a next stage both located on the other side controls the compensation unit outputting a control signal to the other terminal of the scan line synchronously.

2. The display panel as recited in claim 1, wherein the control signal is generated according to a first clock signal.

3. The display panel as recited in claim 1, wherein the compensation unit is controlled by the signal of a second main node of the second shift register unit and the signal of a third main node of the third shift register unit of the next stage, and at least one of the signals of the second and third main nodes has a high level voltage higher than the high level voltage of the scan signal.

4. The display panel as recited in claim 3, wherein the third shift register unit is the next stage of the first shift register unit.

5. The display panel as recited in claim 3, wherein the compensation unit includes two transistors, and the signals of the main nodes control the gate terminals of the transistors, respectively.

6. The display panel as recited in claim 5, wherein a first terminal of each of the transistors is coupled to the scan line while a second terminal of each of the transistors is controlled by the first clock signal.

7. The display panel as recited in claim 2, wherein the first shift register unit includes a first transistor, a capacitor, and a first main node, one terminal of the capacitor is coupled to the first main node and the gate terminal of the first transistor, and the other terminal of the capacitor is coupled to a first terminal of the first transistor and the scan line.

8. The display panel as recited in claim 7, wherein a second terminal of the first transistor is controlled by the first clock signal.

9. The display panel as recited in claim 8, wherein the first shift register unit further includes a second transistor and a third transistor, a first terminal of the second transistor and a second terminal of the third transistor are both coupled to the first main node, a second terminal and gate terminal of the second transistor are coupled to each other, a first terminal of the third transistor is directly coupled to a low level voltage

10. The display panel as recited in claim 9, wherein the gate terminal of the third transistor is controlled by a scan signal outputted by a fourth shift register unit.

11. The display panel as recited in claim 10, wherein the fourth shift register unit is the next second stage of the first shift register unit.

12. The display panel as recited in claim 9, wherein the gate terminal of the third transistor is controlled by a second clock signal, the pulse of the second clock signal is not overlapped with that of the first clock signal.

13. The display panel as recited in claim 9, wherein the gate terminal and second terminal of the second transistor are controlled by a scan signal outputted by the second shift register unit.

14. The display panel as recited in claim 3, wherein the second shift register unit is controlled by a third clock signal, and the pulse of the third clock signal is overlapped with that of the first clock signal.

15. The display panel as recited in claim 14, wherein the third shift register unit is controlled by a fourth clock signal, and the pulse of the fourth clock signal is overlapped with that of the first clock signal but not overlapped with that of the third clock signal.

16. The display panel as recited in claim 3, wherein the second shift register unit is controlled by a third clock signal, and the pulse of the third clock signal is not overlapped with that of the first clock signal.

17. The display panel as recited in claim 16, wherein the third shift register unit is controlled by a fourth clock signal, and the pulse of the fourth clock signal is not overlapped with that of the first clock signal and that of the third clock signal.

18. The display panel as recited in claim 9, wherein the first shift register unit further includes a fourth transistor, a fifth transistor, and a sixth transistor, the gate terminal of the fourth transistor, a first terminal of the fifth transistor, and a second terminal of the sixth transistor are all coupled to the first main node, a first terminal of the fourth transistor and a first terminal of the sixth transistor are both directly coupled to a low level voltage, a second terminal of the fourth transistor is coupled to the scan line, and a second terminal and the gate terminal of the fifth transistor are coupled to each other.

19. The display panel as recited in claim 18, wherein the first shift register unit further includes a seventh transistor, a first terminal of the seventh transistor is coupled to the first main node, and a second terminal and gate terminal of the seventh transistor are coupled to each other.

20. The display panel as recited in claim 7, wherein the signal of the first main node has a high level higher than the high level of the scan signal outputted by the first shift register unit.
